(19) United States
(12) Patent Application Publication
(10) Pub. No.: US 2005/0203912 A1
(43) Pub. Date: Sep. 15, 2005

(54) Method and apparatus for configuring a mobile device

(75) Inventors: Robert Beach, Los Altos, CA (US); Kevin L. Prest, Cupertino, CA (US); Andy Werback, San Jose, CA (US)

Correspondence Address: WILLIAMS, MORGAN & AMERSON, P.C., 10333 RICHMOND, SUITE 1100, HOUSTON, TX, 77042, US

(73) Assignee: Symbol Technologies, Inc.

(21) Appl. No.: 10/800,452

(22) Filed: Mar. 15, 2004

(51) Int. Cl. G06F 7/00

(52) U.S. Cl. 707/10

(57) ABSTRACT

A method for configuring a mobile device includes receiving at least one of an audio and a video signal encoded with configuration data from an interface unit proximate the mobile device and configuring the mobile device based on the configuration data. In another embodiment, the method includes initiating a client-to-client connection between the mobile device and an interface unit coupled to the communication network, receiving configuration data from the interface unit over the client-to-client connection, and configuring the mobile device based on the configuration data.

### BACKGROUND OF THE INVENTION

1. Field of the Invention

This invention relates generally to wireless networks, and, more particularly, to a method and apparatus for configuring a mobile device.

2. Description of the Related Art

A Wireless Local Area Network (WLAN) is a flexible data communications system that can either replace or extend a wired LAN to provide added functionality. A traditional, wired local area network (LAN) sends packets of data from one piece of equipment to another across cables or wires. A wireless local area network (WLAN) relies instead upon radio waves to transfer data. Data is superimposed onto a radio wave through a process called modulation, and this carrier wave then acts as the transmission medium, taking the place of a wire.

The importance of WLAN technology, however, goes beyond just the absence of wires. The advent of the WLAN opens up a whole new definition of what a network infrastructure can be. No longer does an infrastructure need to be solid and fixed, difficult to move, and expensive to change. Instead, it can move with the user and change as fast as the organization does. For example, business people can stay connected as they move throughout the corporate campus, easily tapping into the resources of the wired network.

Wireless Local Area Network technology has been targeted by analysts as one of the fastest growing sectors in the computing industry. WLANs are used in various vertical and horizontal applications (e.g., retail, manufacturing, logistics, healthcare, education, public space, etc.). A variety of wireless network standards have become popular, including the 802.11 family of standards that have ratified by the Institute of Electrical and Electronics Engineering (IEEE). Exemplary IEEE 802.11 standards include 802.11, 802.11a, 802.11b (also known as Wi-Fi), and 802.11g.

Recently, there has been a surge in the deployment of 802.11-based wireless infrastructure networks especially in public “hot spots” covering airports, hotels, coffee shops, etc. to provide wireless internet access services. In the future, further proliferation of demanding multimedia applications, e.g., music and video streaming, and new location-based services are expected.

Portable digital devices have been developed that facilitate both data and voice communication over a wireless network. Such voice communication is commonly referred to as voice over internet protocol (VOIP) communication. Voice data is compressed into packets and delivered to the destination in a manner that is similar to the handling of data packets.

To operate a mobile device on a wireless network, a number of network related configuration items must be entered into the device. This configuration information may include an extended service set (ESS) identifier, user name, password, an internet protocol (IP) address, or the like. In addition, various application specific configuration information items may also be required. For example, for a VOIP device, additional configuration information may include the call control and authentication protocol to be used.

Some mobile devices may have one or more peripherals by which configuration information may be entered. For example, a keypad or a touch screen and a display may be provided. There may also be a barcode scanner, serial port, and/or plug-in card for entering the configuration data.

As the size and cost of a wireless interface has been reduced, new classes of devices have been proposed that are specialized for a particular function. These devices include audio headsets, call buttons, bar code scanners, etc. These devices typically have limited peripherals making the entry of configuration information if not impossible, at least cumbersome. For example, there only be 1 to 3 keys and/or no visual display. Thee may be no serial port or plug-in interface. Configuration of such devices is still necessary, but is made difficult owing to the lack of peripherals.

The present invention is directed to overcoming, or at least reducing the effects of, one or more of the problems set forth above.

### SUMMARY OF THE INVENTION

One aspect of the present invention is seen in a method for configuring a mobile device includes receiving at least one of an audio and a video signal encoded with configuration data from an interface unit proximate the mobile device and configuring the mobile device based on the configuration data.

In another embodiment, the method includes initiating a client-to-client connection between the mobile device and an interface unit coupled to the communication network, receiving configuration data from the interface unit over the client-to-client connection, and configuring the mobile device based on the configuration data.

Another aspect of the present invention is seen in a mobile device including at least one of an audio sensor and a video sensor and a processing unit coupled to at least one of the audio sensor and the video sensor. The processing unit is adapted to receive a signal encoded with configuration data through at least one of the audio sensor and the video sensor from an interface unit proximate the mobile device and configure the mobile device based on the configuration data.

Still another aspect of the present invention is seen in a communication system including a communication network, an interface unit coupled to the communication network, and a mobile device. The mobile device includes a processing unit adapted to initiate a client-to-client connection between the mobile device and the interface unit, receive configuration data from the interface unit over the client-to-client connection, and configure the mobile device based on the configuration data.

### BRIEF DESCRIPTION OF THE DRAWINGS

The invention may be understood by reference to the following description taken in conjunction with the accompanying drawings, in which like reference numerals identify like elements, and in which:

FIG. 1 is a diagram of a communication system in accordance with one embodiment of the present invention;

FIG. 2 is diagram of a headset that may function as a mobile device in the communication system of FIG. 1;

FIG. 3 is a simplified block diagram of a processing unit employed in the headset of FIG. 2;

FIG. 4 is a diagram illustrating the headset of FIG. 2 interfacing with a display for facilitating communication of configuration data therebetween; and

FIG. 5 is a diagram illustrating the headset of FIG. 2 interfacing with an audio source for facilitating communication of configuration data therebetween.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

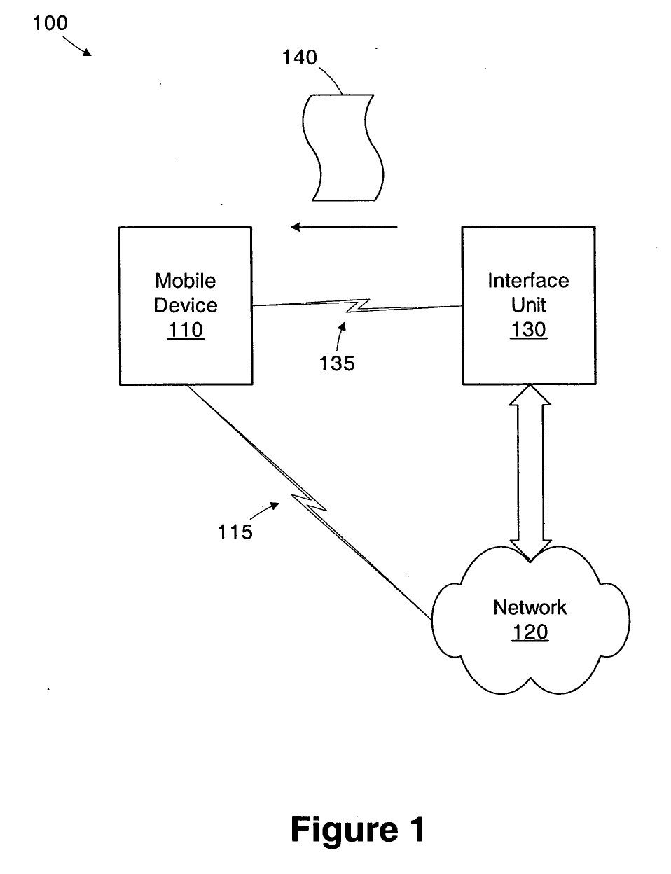

Referring now to the Figures, and first to FIG. 1, a simplified block diagram of a communication system 100 in accordance with one embodiment of the present invention is provided. A mobile device 110 seeks to establish a connection 115 (e.g., an 802.11 type connection) for accessing a network 120, however, prior to securing such access, the mobile device 110 must be provided with configuration data related to the network 120 or to a particular application that the mobile device 110 will be accessing over the network 120. For example, the configuration data may include an extended service set (ESS) identifier, user name, password, an internet protocol (IP) address, a call control protocol selection, and an authentication protocol selection. However, the application of the present invention is not limited to any particular configuration data, as the requirements for such data will be implementation specific. In some embodiments, the mobile device 110 may employ a voice over internet protocol (VOIP) for interfacing with the network 120.

Those of ordinary skill in the art are familiar with the construct of a wireless network, the commands and protocols for accessing such a network, and the types of configuration data required to enable communication between the mobile device 110 and the network. Accordingly, for clarity and to avoid obscuring the instant invention, further details are not provided as to this aspect of implementing the illustrated embodiment.

In the embodiment illustrated in FIG. 1, the mobile device 110 communicates with an interface unit 130 over a connection 135 for receiving configuration data 140. Following such configuration, the mobile device 110 may be configured to access the network 120 directly by establishing the connection 115. The nature of the connection 130 between the mobile device 110 and the interface unit 130 may vary, as described in the exemplary embodiments provided below.

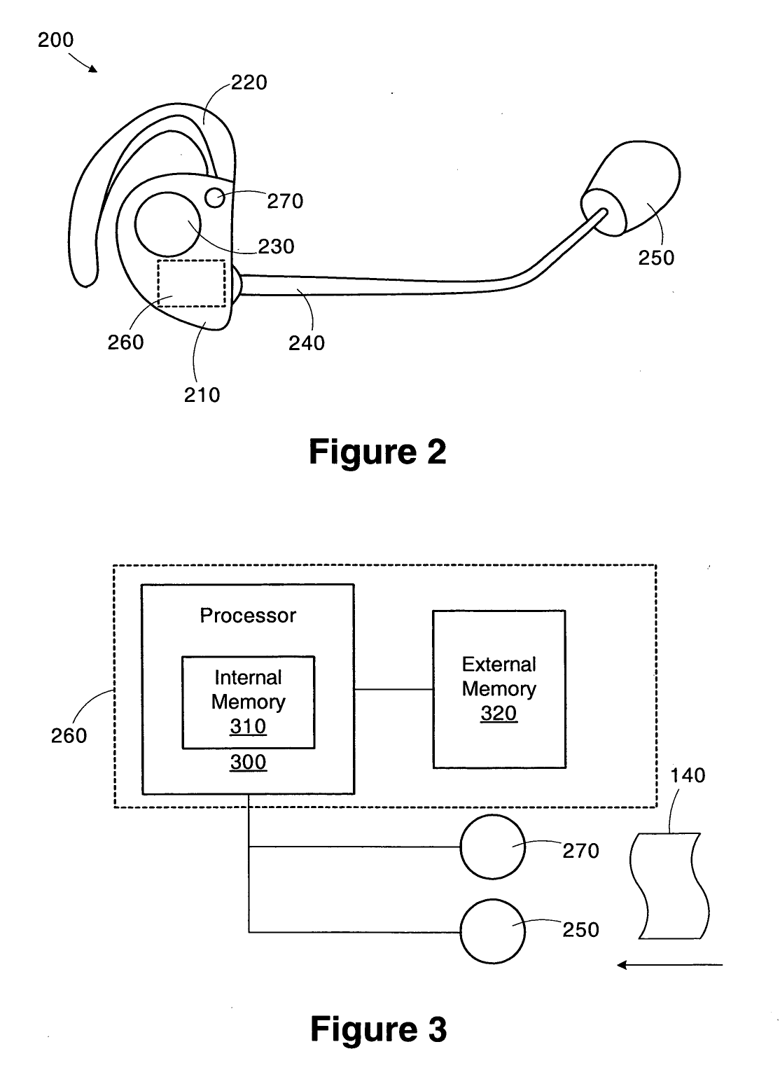

Turning now to FIG. 2, a diagram of a headset 200 that may function as the mobile device 110 in the communication system 100 of FIG. 1 is provided. Although the application of the present invention is described as it may be implemented for configuring the headset 200, the invention is not so limited, and may be applied to any number of classes of mobile devices 110. The headset 200 includes a housing 210 from which extends an earpiece 220 by which a user may wear the headset 200 over an ear. The housing 210 also supports a speaker 230. A boom 240 terminating in a microphone 250 extends from the housing 210. A processing unit 260 is provided for performing the computing functions necessary for communicating with the network 120 of FIG. 1. In some embodiments, a sensor 270 may be provided for establishing the connection 135 with the interface unit 130 of FIG. 1.

FIG. 3 is a simplified block diagram of the processing unit 260 employed in the headset 200 of FIG. 2. The processing unit 260 includes a processor 300 that executes program instructions for implementing the protocols necessary for communicating over the network 120. The processor 300 interfaces with the microphone 250 or sensor 270 for receiving the configuration data 140 from the interface unit 130, as described in specific embodiments below. For clarity and ease of illustration, the functions of the processor 300 for communicating over the network 120 and enabling the speaker 230 and the microphone 250 are not described in greater detail. The processor 300 may comprise a variety of types, such as a general processor, a digital signal processor, an application specific integrated circuit, etc. One exemplary processor 300 that may be employed is a TMS320VC5470, which contains both a TI DSP CPU and an ARM7TDMI microcontroller unit (MCU), offered by Texas Instruments, Inc. of Dallas, Tex. Of course, a wide variety of processors 300 may be used, and the application of the present invention is not limited to any particular type or model. The processor 300 may include internal memory 310 and/or external memory 320 for storing items such as the configuration data 140 received, program instructions, send or receive data, etc. At least a portion of the memory 310, 320 may be non-volatile (e.g., flash memory), such that the configuration data 140 is not erased upon a loss or power or reset of the device.

Returning briefly to FIG. 1, the interface unit 130 may take on a variety of forms. For example, the interface unit 130 may include another client on the network 130, such as a notebook computer, personal data assistant (PDA), desktop computer, or some other device. The interface unit 130 may be connected to the network 120 through a wired or non-wired connection. In some embodiments, the interface unit 130 may actually implement the network 120. For example, the network 120 may comprise a desktop computer including hardware enabling it to act as a wireless access point. The mobile device 110 may connect to the network 120 through the interface unit 130 for communication, as opposed to directly connecting to the network 120 as illustrated.

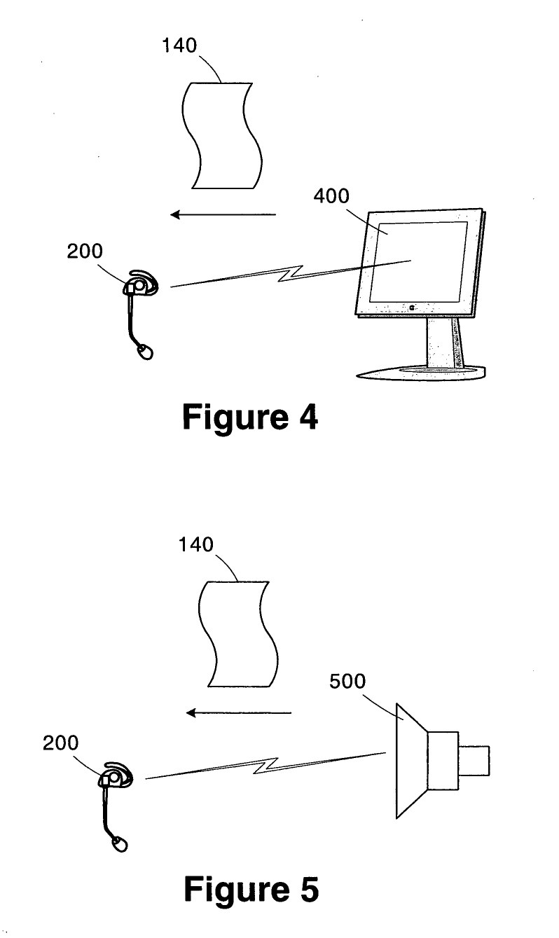

Turning now to FIG. 4, a first embodiment of a technique for interfacing the mobile device (e.g., the headset 200) with a display 400 of the interface unit 130 in accordance with the present invention is shown. Visual patterns may be presented on the display 400 for communicating the configuration data 140 to the headset 200. The configuration data may be displayed in a number of ways. For example, the configuration data may be encoded as a series of on-off flashes, similar to a signal semaphore (e.g., Morse Code). A second technique may be to provide a moving pattern similar to a bar code.

In such embodiments, the sensor 270 is employed to receive the visual signal. The sensor 270 may comprise a photocell set behind a lens (not shown) or hole (not shown) in the housing 210. A user of headset 200 may place the headset 200 in close proximity to the display 400 so that the sensor 270 may detect the pattern displayed. The headset 200, after receiving the configuration data 140 may configure the protocols and addresses used by the processor 300. The processor 300 may then establish the connection 115 (shown in FIG. 1) with the network 120 and send a confirmation message (e.g., 802.11 message) to the interface unit 130 (e.g., the display 400 or computer system including the display 400) through the network 120. Alternatively, the processor 300 may provide the user with local indication of the configuration success, such as through an audible beep through the speaker 230.

The configuration sequence may be repeated for a predetermined number of times, and the user may be notified if the configuration was not properly completed within an acceptable time interval. For example, an error in the configuration data may prevent the establishment of the connection 115.

FIG. 5 depicts a second embodiment of a technique for interfacing the mobile device (e.g., the headset 200) with an audio source (e.g., speaker) 500 of the interface unit 130 in accordance with the present invention. Audio patterns may be issued through the speaker 500 and received by the microphone 250 for communicating the configuration data 140 to the headset 200. The configuration data may communicated audibly in a number of ways. For example, the configuration data may be encoded using a frequency shift keying (FSK) audio sequence played as tones on the speaker 500. Of course, other modulation techniques may be used, such as an acoustic modem (e.g., 300-2400 baud) signal or a Morse code signal. In some embodiments, the headset 200 may be equipped with speech recognition functionality. The interface unit 130 may provide the user with a visual (e.g., screen or printout) display of the configuration data. The user may speak the configuration data into the speaker 500. The processor 300 may detect letters, words, or numbers in the spoken signal from the user and extract the configuration data therefrom. In some embodiments, the processor 300 may perform a voice print analysis to authenticate the user, such that only the approved user may configure the device to access the network 120.

As with the embodiment of FIG. 4, the user of headset 200 may place the headset 200 in close proximity to the audio source 500 so that the microphone 250 may detect the audible pattern. Again, the headset 200, after receiving the configuration data 140 may configure the protocols and addresses used by the processor 300. The processor 300 may then establish the connection 115 (shown in FIG. 1) with the network 120 and send a confirmation message, such as a network message or audible beep indicating successful connection to the network 120. The configuration sequence may be repeated for a predetermined number of times, and the user may be notified if the configuration was not properly completed within an acceptable time interval.

A third technique for communicating the configuration data 140 to the mobile device 110 is described in reference to FIG. 1. In a typical mode of operation, users, such as the mobile device 110, connect to the network 120 through designated access points or gateways. If one user wishes to communicate with a second user, such communication is received by the network 120 from one user through the access point and then transmitted to the second user, again through the access point. In essence, the network 120 acts as an intermediary between the clients.

Wireless network protocols sometimes define a client-to-client connection mode, where the intermediary function is bypassed and the clients communicate with one another directly. In accordance with the 802.11 standard, the client-to-client mode is referred to as an independent basic service set (IBSS) mode. In this particular embodiment, the connection 135 is a client-to-client connection between the mobile device 110 and the interface unit 130. The mobile device 110 broadcasts a public key with an accompanying configuration request. The interface unit 130 receives the request and public key and uses the public key to encrypt the configuration data 140. The mobile device 110 receives the encrypted configuration data 140 and decrypts it using its associated private key. The mobile device 110 can then employ the configuration data and establish the connection 115 with the network. Again, the mobile device 110 may send a confirmation or time out message to the user (e.g., through the network connection 115, through the client-to-client connection 135, or through an audible beep).

In the client-to-client embodiment, there is a possibility that some other entity (not shown) other than the interface unit 130 may send a false public key using an address associated with the mobile device 110. In such a case, the interface unit 130 may be deceived into sending confidential count information (e.g., username and/or password) to the intruding entity. To address this possibility, the user may be required to place the mobile device 110 in close proximity to the interface unit 130 (e.g., a few inches). The interface unit 130 measures the receive signal strength indication (RSSI) parameter for the access request and compares it to a predetermined threshold. If the mobile device 110 is only a few inches from the interface unit 130, the RSSI should be at its maximum value. As a result of the physics of radio propagation, such a strong signal can typically only be generated by a device in very close proximity. Devices just a few feet away or using a highly directional antenna cannot generate such a high RSSI value. Hence, the interface unit 130 may identify a possible intruder based on a lower RSSI value. The mobile device 110 may also employ a similar RSSI technique to authenticate communication from the interface unit 130 including the configuration data.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method for configuring a mobile device, comprising:
receiving at least one of an audio and a video signal encoded with configuration data from an interface unit proximate the mobile device; and
configuring the mobile device based on the configuration data.

2. The method of claim 1, further comprising initiating a connection between the mobile device and a communication network responsive to configuring the mobile device.

3. The method of claim 2, wherein the interface unit is coupled to the communication network, and the method further comprises sending a confirmation message from the mobile device through the communication network to the interface unit responsive to initiating the connection.

4. The method of claim 1, further comprising providing a confirmation signal to a user of the mobile device responsive to configuring the mobile device.

5. The method of claim 4, wherein providing the confirmation signal further comprises providing an audible signal to the user.

6. The method of claim 5, wherein the mobile device comprises a headset having a speaker and providing the audible signal to the user comprises providing the audible signal through the speaker.

7. The method of claim 1, wherein the mobile device comprises a headset having a microphone and the method further comprises receiving the audio signal through the microphone.

8. The method of claim 1, wherein the mobile device comprises a headset having a sensor and the method further comprises receiving the video signal through the sensor.

9. The method of claim 1, wherein the interface unit is adapted to display the configuration data and receiving the at least one of the audio and the video signal further comprises receiving a speech signal from a user including the configuration data.

10. A method for configuring a mobile device to access a communication network, comprising:
initiating a client-to-client connection between the mobile device and an interface unit coupled to the communication network;
receiving configuration data from the interface unit over the client-to-client connection; and
configuring the mobile device based on the configuration data.

11. The method of claim 10, further comprising initiating a connection between the mobile device and the communication network responsive to configuring the mobile device.

12. The method of claim 11, further comprising sending a confirmation message from the mobile device through the communication network to the interface unit responsive to initiating the connection between the mobile device and the communication network.

13. The method of claim 10, further comprising providing a confirmation signal to a user of the mobile device responsive to configuring the mobile device.

14. The method of claim 13, wherein providing the confirmation signal further comprises providing an audible signal to the user.

15. The method of claim 14, wherein the mobile device comprises a headset having a speaker and providing the audible signal to the user comprises providing the audible signal through the speaker.

16. The method of claim 10, wherein initiating the client-to-client connection further comprises sending a public key from the mobile device to the interface unit and receiving the configuration data further comprises receiving the configuration data encrypted with the public key.

17. The method of claim 16, further comprising decrypting the configuration data encrypted with the public key using a private key associated with the public key.

18. The method of claim 10, further comprising:
determining a signal strength parameter associated with the mobile device; and
sending the configuration data responsive to the signal strength parameter exceeding a predetermined threshold.

19. The method of claim 10, further comprising:
determining a signal strength parameter associated with the interface unit; and
configuring the mobile device based on the configuration data responsive to the signal strength parameter exceeding a predetermined threshold.

20. A mobile device, comprising:
at least one of an audio sensor and a video sensor; and
a processing unit coupled to at least one of the audio sensor and the video sensor and adapted to receive a signal encoded with configuration data through at least one of the audio sensor and the video sensor from an interface unit proximate the mobile device and configure the mobile device based on the configuration data.

21. The system of claim 20, wherein the processing unit is further adapted to initiate a connection with a communication network responsive to configuring the mobile device.

22. The system of claim 21, wherein the processing unit is further adapted to send a confirmation message through the connection with the communication network to the interface unit responsive to initiating the connection with the communication network.

23. The system of claim 20, wherein the processing unit is further adapted to provide a confirmation signal to a user of the mobile device responsive to configuring the mobile device.

24. The system of claim 23, wherein the confirmation signal further comprises an audible signal.

25. The system of claim 24, wherein the mobile device comprises a headset having a speaker, and the processing unit is further adapted to send the audible signal through the speaker.

26. The system of claim 20, wherein the mobile device comprises a headset having a microphone coupled to the processing unit, and the processing unit is further adapted to receive the signal through the microphone.

27. The system of claim 20, wherein the mobile device comprises a headset having a sensor coupled to the processing unit, and the processing unit is further adapted to receive the signal through the sensor.

28. The system of claim 20, wherein the signal further comprises a speech signal.

29. A communication system, comprising:
a communication network;
an interface unit coupled to the communication network; and
a mobile device including a processing unit adapted to initiate a client-to-client connection between the mobile device and the interface unit, receive configuration data from the interface unit over the client-to-client connection, and configure the mobile device based on the configuration data.

30. The system of claim 29, wherein the processing unit is adapted to initiate a connection with the communication network responsive to configuring the mobile device.

31. The system of claim 30, wherein the processing unit is further adapted to send a confirmation message through the connection with communication network to the interface unit responsive to initiating the connection with the communication network.

32. The system of claim 29, wherein the processing unit is further adapted to provide a confirmation signal to a user of the mobile device responsive to configuring the mobile device.

33. The system of claim 32, wherein the confirmation signal further comprises an audible signal.

34. The system of claim 33, wherein the mobile device comprises a headset having a speaker and the processing unit is further adapted to provide the audible signal through the speaker.

35. The system of claim 29, wherein the processing unit is further adapted to send a public key to the interface unit and the interface unit is adapted to encrypt the configuration data with the public key prior to sending the configuration data to the processing unit.

36. The system of claim 35, wherein the processing unit is further adapted to decrypt the configuration data encrypted with the public key using a private key associated with the public key.

37. The system of claim 29, wherein the interface unit is further adapted to determine a signal strength parameter associated with the mobile device and send the configuration data responsive to the signal strength parameter exceeding a predetermined threshold.

38. The system of claim 29, wherein the processing unit is further adapted to determine a signal strength parameter associated with the interface unit and configure the mobile device based on the configuration data responsive to the signal strength parameter exceeding a predetermined threshold.

39. An apparatus, comprising:
means for receiving at least one of an audio and a video signal encoded with configuration data from an interface unit proximate a mobile device; and
means for configuring the mobile device based on the configuration data.

40. A system, comprising:
means for initiating a client-to-client connection between a mobile device and an interface unit coupled to a communication network;
means for receiving configuration data from the interface unit over the client-to-client connection; and
means for configuring the mobile device based on the configuration data.
